(19) United States
(12) Patent Application Publication
(10) Pub. No.: US 2012/0260543 A1
(43) Pub. Date: Oct. 18, 2012

(54) Display Device for a Cord

(76) Inventors: Scott E. Dunn, Atlanta, GA (US); Lance Trenton Culpepper, Atlanta, GA (US)

(21) Appl. No.: 13/367,352

(22) Filed: Feb. 6, 2012

Related U.S. Application Data
(60) Provisional application No. 61/439,606, filed on Feb. 4, 2011.

(51) Int. Cl. G09F 3/02

(52) U.S. Cl. 40/316

(57) ABSTRACT

Display devices for a cord are provided. The display device has a display surface for displaying a message or idea. The display surface can be sized, shaped and colored to display the message. Text or images can be applied to the display surface. A notch formed in the display device is sized for selective attachment to the cord of an electronic device such as a computer, MP3 player, or cellphone.

### CROSS REFERENCE TO RELATED APPLICATIONS

This application claims priority to and the benefit of US. Provisional Application No. 61/439,606, filed on Feb. 4, 2011, which is incorporated in its entirety in this document by reference.

### FIELD OF THE INVENTION

This invention relates to the field of display devices. More specifically, this invention relates to display devices that are attachable to a cord.

### BACKGROUND OF INVENTION

This application comprises a display device that uses several embodiments to display messages, objects, advertisements, slogans, sports teams, geographic areas, companies, countries, cities, pictures, vacation destinations, interests from popular culture, colors or any other area of interest the user may have. This application further comprises a method to attach a display area in the form of, for example and without limitation, a flag/ribbon/tag or bead to power cords. Examples of cords include but are not limited to lap top cords, tablet computer power cords, MP3 headphone cords, cell phone chargers, and mouse cords. The display device can be attached to cords that vary in size or shape. The display device provides a display surface that is visible to the user and other people while the electronic equipment is in use as well as allowing for the user and others to view the display device while it is being charged or not in use. It is contemplated that the increased use of electronic devices such as MP3 players, cell phones, laptops and the like has provided a unique opportunity to use the exposed surface of the power cords and headphones for the purpose of providing a display device. These cords typically are used for extended periods of time and are in plain sight of the user and others. Normally these cords are not hidden and have a prominent place in the daily life of the user.

Examples of known display devices that attach directly to power cords are limited to technical flags used in the IT business for the purpose of writing routing numbers on cables. These are not meant to be viewed by the general public and have little visual appeal nor do they allow for creative expression or advertising. It is apparent that there is a need for a device that allows these messages or interests to be displayed and that has low manufacturing cost. The display device will have the ability to use a variety of different materials for the flag/tag/ribbon such as plastic or cloth and the use of a bead to convey the same message in a limitless source of shapes, sizes and colors.

### SUMMARY OF THE INVENTION

In accordance with the purposes of this invention, as embodied and broadly described herein, this invention, in one aspect, relates to a display device that is attachable to a cord. The display device, in one aspect, comprises a display surface and a notch or clip. The display device can be constructed of, for example, plastic, rubber or metal and the like. The notch or clip is sized for receiving a cord so that the display device id attachable to the cord and allows for the display surface to be presented in an appealing fashion. In one aspect, the display device can be formed in a variety of shapes and sizes. In another aspect, the display device comprises a hook and loop material to allow for selective attachment of the display device to the cord. In this aspect, the display device can be attached to many different sizes and shapes of cords. In another aspect, the display device can be constructed from a single type of material and can have the notch of the display device incorporated into the body of the display device. In this aspect, the notch can be formed in the display surface for the purpose of displaying an image directly on the display device. Alternatively, the display surface can be attached to the clip. It is contemplated that a display can be printed, painted, or attached to the display surface with a sticker or other adhesive.

In one aspect, the display device can comprise a one-piece assembly. In this aspect, the display device can easily be manufactured in a fashion so that the display device requires no additional assembly.

In another aspect, the display surface can be formed to represent any object or shape. For example, the display surface can be a square, rectangle, circle, oval, or other common shape. In other examples, the display surface can be formed into the shape of, for example and without limitation, a flag, decorative bead, company logo, a common object such as, but not limited to: a) objects from nature (animals, stars, trees, the Earth); b) company logos; c) items from popular culture (stars likeness, little kitty) etc.; d) man-made objects (car, guitars, any manufactured item of interest). As can be appreciated, there can be many variations on the shape of the display surface.

In one aspect, at least a portion of the display device can be formed using a predetermined color or range of colors. A pink bead, for example, might be used to raise awareness of breast cancer and at the same time be used simply for the purpose of displaying the color pink. In this aspect, a message can be displayed on the display surface, in addition to the predetermined color of the display device to convey an additional message or idea.

In one aspect, the display device can vary in size to accommodate the various sized cords to which it can be attached. The display device can securedly attach to the intended cord as well as display an image or message on the display surface. In another aspect, the display device can be attached to the cord to allow for the proper presentation of the display surface, so that the display surface is presented in a form that is easily viewed regardless of the material used to construct the display surface.

In one aspect, the display surface of the display device comprises a flag, a tag, and/or a ribbon. In this aspect, the flag/tag/ribbon can be formed from a different material than other portions of the display device. In another aspect, an outer end of the display device can allow the attachment of the flag/tag/ribbon to a cord. The flag/tag/ribbon can be attached to a cord by at least one of gluing the tag in place, heat sealing, applying pressure to the display device or inserting a plastic or metal “tab” or by snapping/sliding the display area on the clip and the like. In a further aspect, a hook and loop fastener can be used to attach the display device to a cord. For example, the flag/tag/ribbon can be looped around the cord for the purpose of attaching a non-like-kind material as a display area.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a plurality of views of a display device, according to one aspect.

FIG. 1.1 is a plurality of views of the display device of FIG. 1, showing the display device formed into a variety of shapes.

FIG. 2 is a plurality of views of a display device, according to one aspect.

FIG. 2.1 is a plurality of views of the display device of FIG. 2, showing the display device formed into a variety of shapes.

FIG. 3 is a plurality of views of a display device attachable to cords of varying width, according to one aspect.

FIGS. 3.1, 3.2, and 3.3 are a plurality of views of the display device of FIG. 3, showing the display device formed into a variety of shapes.

FIG. 4 is a plurality of views of a display device comprising a flag, tag and/or a ribbon, according to one aspect.

FIG. 4.1 is a plurality of views of the display device of FIG. 4, showing the display device formed into a variety of shapes.

FIG. 5 is a plurality of views of a display device comprising at least two pieces, according to one aspect.

FIGS. 5.1, 5.2, and 5.3 are a plurality of views of the display device of FIG. 5, showing the display device formed into a variety of shapes.

FIG. 6 is a plurality of views of a display device comprising at least two pieces, according to one aspect.

FIGS. 6.1, 6.2, and 6.3 are a plurality of views of the display device of FIG. 6, showing the display device formed into a variety of shapes.

FIG. 7 is a plurality of views of a display device comprising at least two pieces, according to one aspect.

FIGS. 7.1 and 7.2 are a plurality of views of the display device of FIG. 7, showing the display device formed into a variety of shapes.

FIG. 8 is a plurality of views of a display device comprising a hook and loop fastener, according to one aspect.

FIGS. 8.1 and 8.2 are a plurality of views of the display device of FIG. 8, showing the display device and/or the hook and loop fastener formed into a variety of shapes.

FIG. 9 is a plurality of views of a display device comprising a button and/or a snap, according to one aspect.

FIG. 9.1 is a plurality of views of the display device of FIG. 9, showing the display device formed into a variety of shapes.

FIG. 10 is a plurality of views of a display device showing a display surface configured to attach to a clip, according to one aspect.

### DETAILED DESCRIPTION OF THE INVENTION

Aspects of the present invention may be understood more readily by reference to the following detailed description, examples, drawings, claims, and their previous and following description. However, before the present apparatuses, systems, and/or methods are disclosed and described, it is to be understood that this invention is not limited to the specific apparatuses, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “clip” can include two or more such clips unless the context indicates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” means that the subsequently described event or circumstance may or may not occur, and that the description includes instances where said event or circumstance occurs and instances where it does not.

Reference will now be made in detail to aspects of the invention, examples of which are illustrated in the accompanying drawings. Wherever possible, the same reference numbers are used throughout the drawings to refer to the same or like parts.

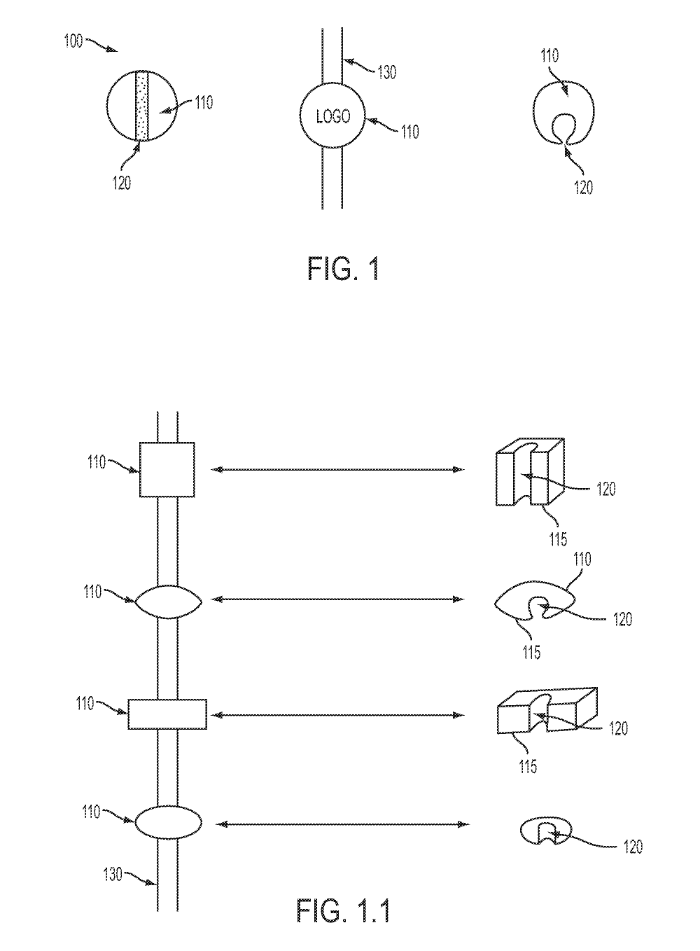

A display device that is attachable to a cord is provided. Referring to FIG. 1, in one aspect, the display device 100 comprises a display surface 110 configured for displaying a message. As used herein, “displaying a message” can mean displaying a message, an idea, a logo, an image or the like, through the use of color, shape, text, figures and the like. In another aspect, at least one notch 120 can be defined in at least a portion of the display device. For example, if the display surface is substantially cylindrical or spherical, as illustrated in FIG. 1, the at least one notch can be defined in the display surface. In other examples, the display device can comprise a display surface 110 and a rear surface 115. In this aspect, with reference to FIG. 1.1, the at least one notch can be defined in the rear surface of the display device. In still another aspect, an outer wall can extend between the display surface and the rear surface. In this aspect, the at least one notch 120 can be defined therein at least a portion of the outer wall. The at least one notch can be sized and or shaped to conform to an electrical cord 130, such as, for example and without limitation, an electrical cord for a computer, an MP3 players, a cell phone, or a mouse. In another aspect, at least a portion of the at least one notch can be substantially circular when viewed in cross-section, though other shapes are contemplated. In use, described more fully below, the at least one notch can be sized and shaped for compressive and frictional attachment of the display device 100 to at least a portion of a cord 130.

The display device 100 can be formed from a material such as plastic, rubber, wood, metal, fabric and the like. In one aspect, the display device can be formed from a single piece of material (i.e., the display device can be a monolithic display device). In other aspects, at least a portion of the display device can be formed from a first material, and a portion of the display device 100 can be formed from a second, different material.

In one aspect, it is contemplated that the display device 100 can be manufactured using an injection molding process. The shape, size and color of the display device 100 can vary. For example, the display device can be formed into the shape of a bead as in FIG. 1. In another example, the display device 100 can be formed so that the display surface 110 of the display device is substantially square, substantially rectangular, substantially oval, or football shaped, as illustrated in FIG. 1.1. Other examples of the shape of the display device 100 and/or the display surface include, but are not limited to, a religious symbol, a flag or other geometric shapes. However, it is contemplated that the display device 100 and/or the display surface can be formed into any size and/or shape. In still another example, at least a portion of the display surface can be substantially planar.

After and/or during manufacturing of the display device 100, a message or image can be positioned onto the display surface 110. For example, a message or image can be printed or painted on the display surface to display an additional message such as a company name, a particular country, a sports team or any other message someone may desire. The message, in one aspect, can be simply a color and/or the message could glow in the dark. In another aspect, it is contemplated that the message can be formed on the display surface 110 during manufacture of the display surface. For example, the message could be molded into the display surface while the display surface itself is being molded. In still another aspect, the message can also be embroidered, engraved, and/or stamped onto the display surface.

In use, the display device 100 can be selectively attached to the cord 130 by snapping the device onto the cord such that at least a portion of the notch 120 surrounds the cord. As discussed above, the notch and can be sized to attach the display device to a cords of predetermined thickness. The display device 100 can be selectively moved on the cord 130 or removed from the cord by pulling the display device 100 off the cord in order to move the display device to another location. In one aspect, if the desired effect is for the display device 100 to be able to slide up and down the cord 130, the notch 120 of the display device can be sized large enough to allow the display device 100 to slide freely up and down the cord 130 while still being firmly attached to the cord.

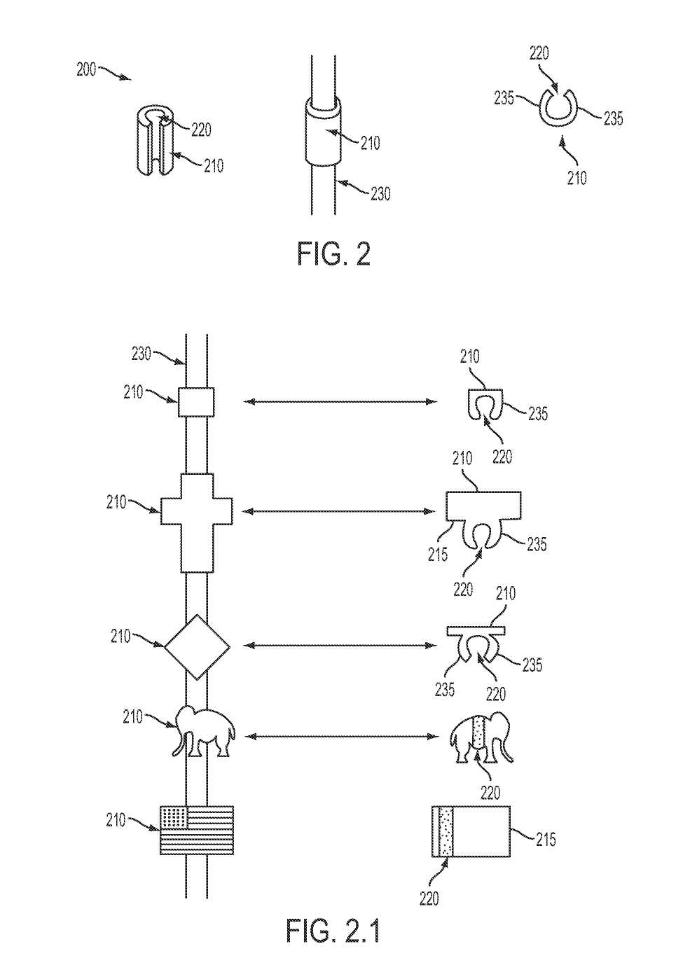

In one aspect, and as illustrated in FIGS. 2 and 2.1, the at least one notch 220 of the display device can be defined between a pair of opposed arms 235 extending from the display device. If the display device is substantially cylindrical, as illustrated in FIG. 2, the pair of arms can form at least a portion of the display surface 210. In another aspect, the pair of arms 235 can extend from the display surface 210 and/or the rear surface 215 of the display device, depending on the shape of the display device. For example, in the first illustration of FIG. 2.1, the pair of arms 235 extend from the display surface 210, while in the second illustration, the pair of arms extend from the rear surface 215 of the display device 200. The pair of arms can be sized so that the notch defined therebetween is configured for attachment to cords of predetermined thickness.

In use, in this aspect, the display device 200 can be selectively attached to the cord 230 by snapping the device onto the cord such that at least a portion of the notch 220 surrounds the cord. In one aspect, when attaching the device to the cord, at least one arm of the pair of arms 235 can flex away from the opposed arm to allow for the cord to enter the notch. Upon the cord 230 entering the notch, the at least one arm can flex back to the original position, thereby securing the cord in the notch 220.

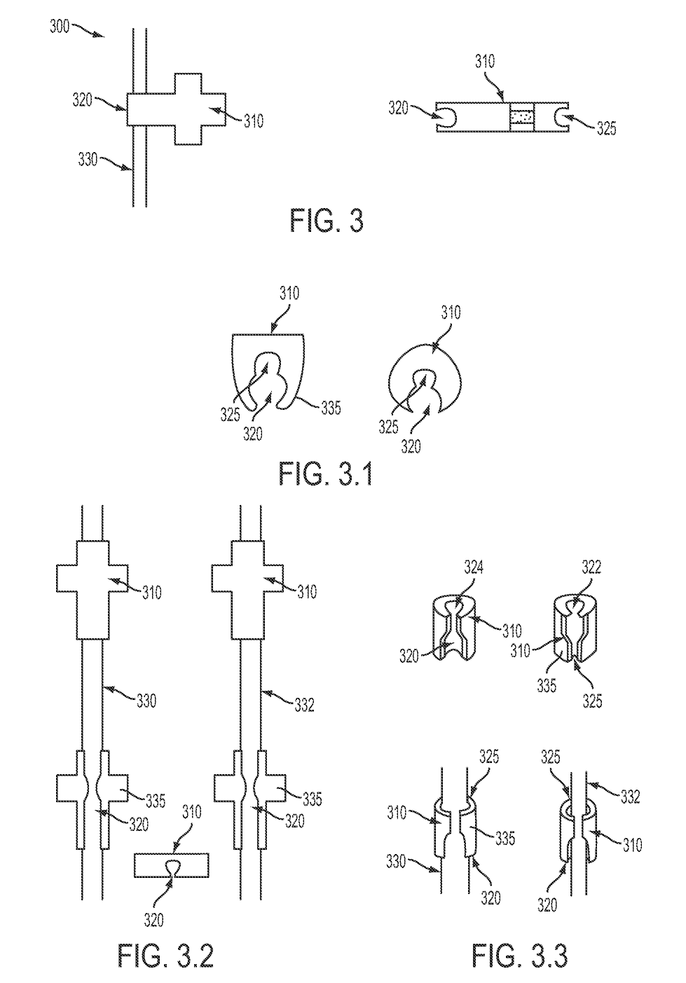

Referring now to FIG. 3, in one aspect, the at least one notch can comprise a plurality of notches 320, 325. In another aspect, a first notch 320 of the plurality of notches can have a first size, and a second notch 325 of the plurality of notches can have a second size that is smaller than the first size. Thus, the first notch can be sized to attach the display device 300 to a cord 330 having a first diameter, and the second notch can be sized to attach the display device to a cord having a second diameter. However, it is also contemplated that the first notch and the second notch can have substantially the same size.

In another aspect, and with reference to FIG. 3.1, the plurality of notches 320, 325 can be defined between the pair of arms 335 extending from the display device. In a further aspect, the second notch 325 can be defined in the display device 300 adjacent to the first notch 320. In this aspect, if a cord has the second diameter, the cord can pass through the first notch and attach to the second notch. Alternatively, if a cord has the first diameter, the cord will not fit into the second notch 325 and can attach to the first notch 320.

In still another aspect, the at least one notch can comprise a notch having a varied size. With reference to FIGS. 3.2 and 3.3, a first end 322 of the notch 320 can have a first size, and the second end 324 of the notch can have a second size that is smaller than the first size. In this aspect, different sized cords 330, 332 can attach to a display device 300 without the need to manufacture the exact notch 320 to match the cord size. For example, a first cord 332 having a first diameter can be attached to the display device 300 by frictional engagement of at least a portion of the first end 322 of the notch 320 with the first cord, and a second cord 330 having a second diameter can be attached to the display device 300 by frictional engagement of at least a portion of the second end 324 of the notch 320 with the second cord.

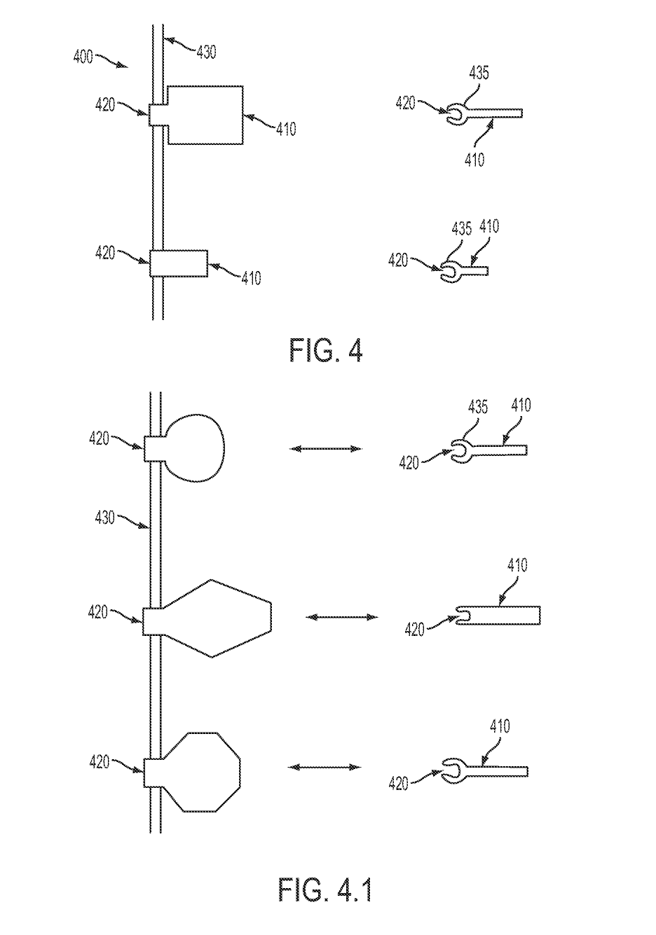

Referring now to FIG. 4, a display device 400 that is attachable to a cord 430 is provided. As previously discussed, the display device comprises a display surface 410 configured for displaying a message and at least one notch 420 defined in at least a portion of the display device. In one aspect, the at least one notch can be defined between a pair of extending arms 435. As illustrated in FIGS. 4 and 4.1, the display surface 410 of the device can be formed in the shape of a flag or any other shape having any other size. In one aspect, the display surface of FIGS. 4 and 4.1 can be larger than the display surface of, for example, the display device illustrated in FIG. 1. In another aspect, at least a portion of the display surface 410 can be substantially planar. This large, planar display surface 410 can be an easy-to-read surface area for displaying the desired message.

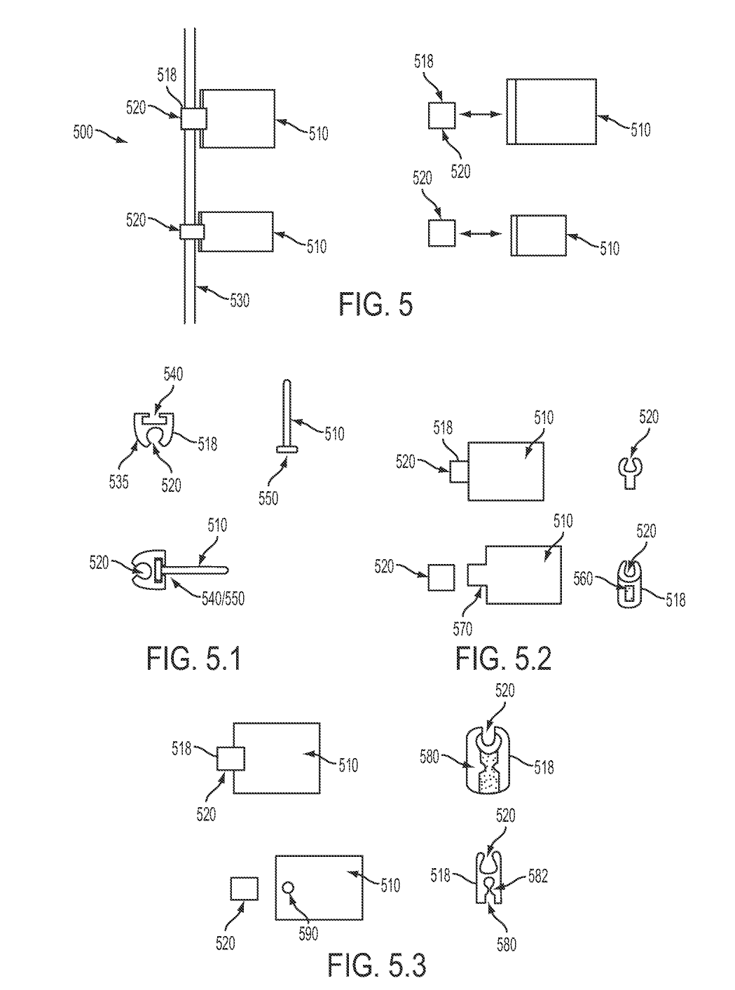

The display device can be formed from a plurality of pieces that can be assembled together. Referring to FIG. 5, in one aspect, the display device 500 comprises a clip 518 and a display surface 510. In another aspect, the at least one notch 520 can be defined in the clip, for example, between the pair of opposed arms 535 such that the clip is attachable to the cord 530. In another aspect and as illustrated in FIG. 5.1, a groove 540 can be defined in the clip, the groove configured for attachment to a corresponding tongue 550 formed in a portion of the display surface 510. In this aspect, the display surface 510 can be slid or snapped into the corresponding groove 540 of the clip 518 to form a display device 500. In another aspect and as illustrated in FIG. 5.2, a slot 560 can be defined in the clip 518, the slot configured for attachment to a corresponding tab 570 formed in a portion of the display surface 510. In this aspect, the tab of the display surface 510 can be slid or snapped into the corresponding slot 560 of the clip 518 to form a display device 500. The tab 570 and slot 560 can be sized for secure attachment of the two pieces. In still another aspect and as illustrated in FIG. 5.3, a gap 580 can be defined in the clip, the gap having a narrowing protrusion 582. An indentation 590 can be defined in a portion of the display surface, the indentation configured for attachment to the protrusion formed in the clip 518. In this aspect, the protrusion 582 of the clip can be slid or snapped into the corresponding indentation 590 of the display surface 510 to form a display device 500. As before, the notch 520 of the display device can be selectively attached to a cord 530, and a message or image can be displayed on the display surface. As can be appreciated, when attached to a cord, the clip 518 can remain on the cord while the display surface 510 can be selectively detached from the clip. Also, the clip 518 can be manufactured separately from the display surface 510.

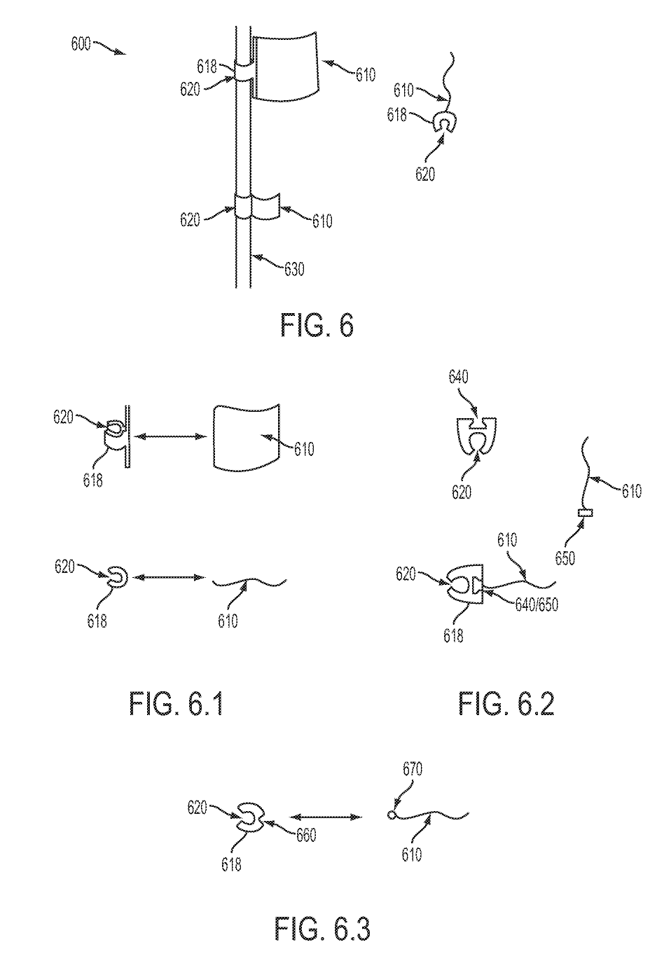

Referring to FIG. 6, in one aspect, the display device 600 can be formed in the shape of a flag or tag and can comprise two or more separate types of material. For example, the clip 618 can be formed from a first material, such as plastic, and the display surface 610 can be formed from a second material, such as cloth or film. The method for assembling the display device 600 differs in this aspect because the different materials need to be joined before the display device is complete. This will allow for a more standard printing process on the display surface 610 of the display device 600. The display surface 610 of the display device 600 can be manufactured similar to a patch or a team flag. In one aspect, the display surface can be formed from a cloth-like or film material and can be printed on directly and/or embroidered for a more detailed and interesting representation of the desired message.

In another aspect, the display surface 610 of the display device can be manufactured separately than the clip 618. For example, the flags/tags/ribbons can be manufactured in a fashion so they can be mass-produced. In one aspect, the display on the display surface 610 can also be printed in a continual fashion further reducing production costs. In another aspect, ribbons/tags/flags can be printed or stitched on a continual spool then attached to the display device and cut. In a further aspect, the flags and/or ribbons can be cut prior to being attached to the display device 600 depending on the type of equipment sourced for the manufacturing process. For example, it is contemplated that when using an injection molding process to produce a plurality of display devices, the display devices can be lined up with the non-like-kind display surface (flag/tag/ribbon) and then cut to the proper size. In another aspect, the flag/ribbon/tag and/or a bead can also be used to simply add color to the cord.

In use, the display surface 610 can be attached to the clip thereby completing the display device 600. Three methods that can be used to attach the display surface 610 to the clip 618 are shown in FIG. 6.1, FIG. 6.2 and FIG. 6.3. One benefit of using one or more of several methods of attaching the display surface to the clip 620 is to make sure with different materials that the connection can be made cost efficiently, have a clean look at the point of attachment and allow for variations in the type of material used to manufacture the display device 600. For example, the display surface 610 can be attached to the clip 618 by gluing the flag directly to an outside edge of the clip as shown in FIG. 6.1. In another example, and as illustrated in FIG. 6.2, a groove 640 can be defined in the clip 618, the groove configured for attachment to a corresponding tongue 650 attached to the display surface. In this aspect, the display surface 610 can be slid or snapped into the corresponding groove 640 of the clip 618 to form a display device 600. In another example, as illustrated in FIG. 6.3, the display surface can be attached to the clip 618 by making an edge 670 of the display surface 610 thicker than other portions of the display surface by sealing the edge, folding it, or attaching other material to the edge 670. This thicker edge can be inserted into a corresponding slot 660 defined in an outer edge of the clip 618. In one aspect, upon insertion of the edge 670 into the slot 660 of the clip, the display surface can be sealed and/or glued into place.

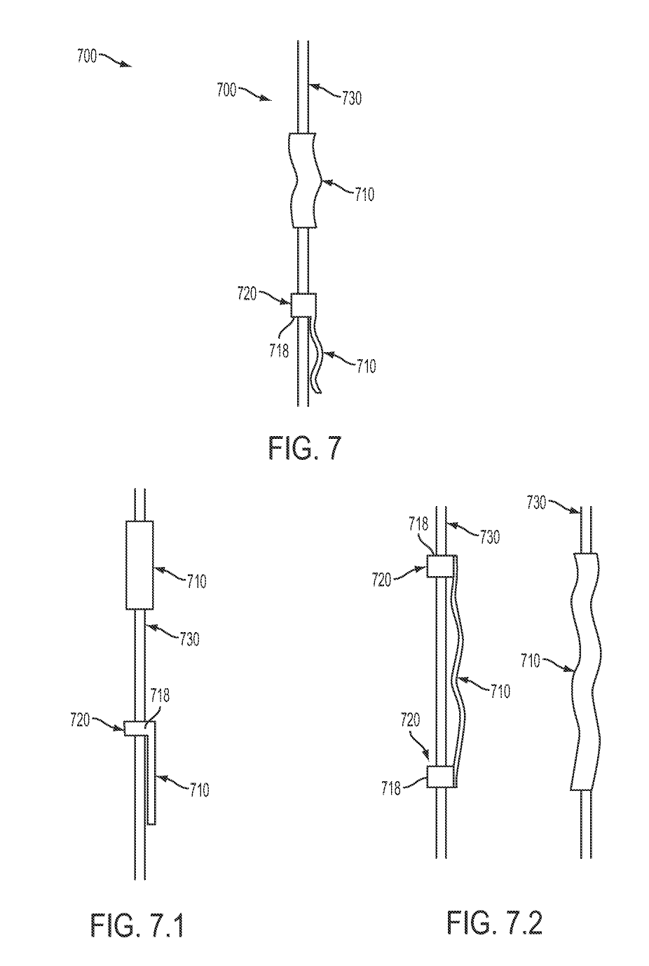

In one aspect and illustrated in FIGS. 7 and 7.1, the display surface 710 can comprise a ribbon attachable to the clip 718 as discussed above. In this aspect, display surface 710 can be made in various shapes, colors and styles of a ribbon. In another aspect, the display device 700 can comprise a plurality of clips 718 and a display surface 710, as illustrated in FIG. 7.2. In this aspect, the notch 720 of each clip can be attachable to the cord 730 and the ribbon display surface can extend between the two clips such that the display surface appears as a banner that runs along the cord 730. Of course, the display surface 710 can be printed, painted and the like for enhancing the display purposes.

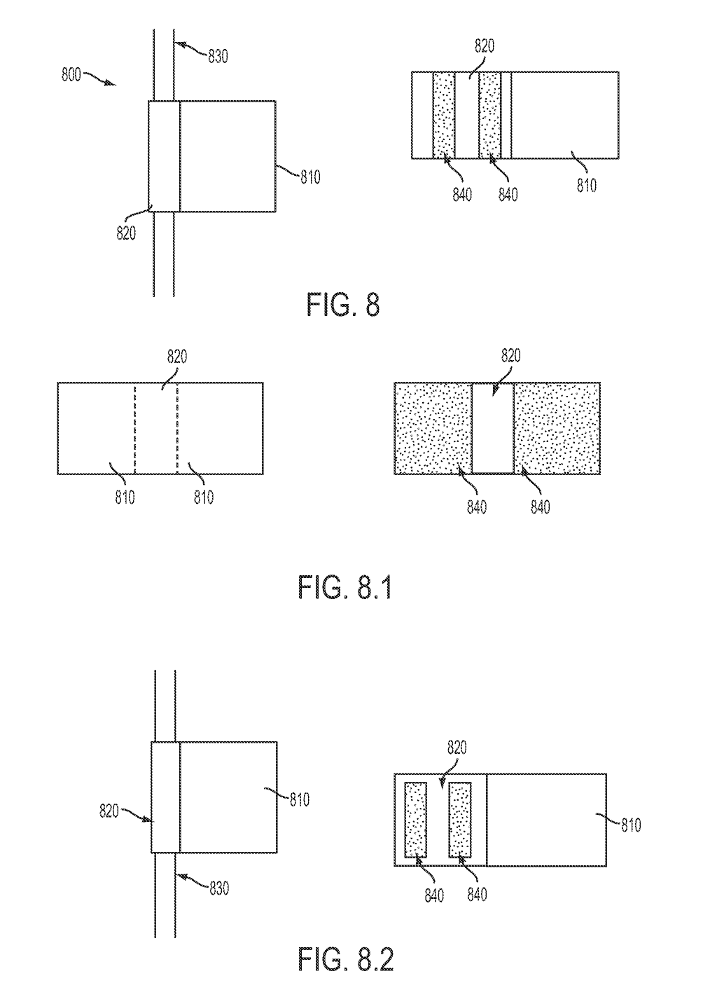

With reference to FIGS. 8, 8.1 and 8.2, in one aspect, the display surface 810 can comprise a hook and loop fastener 840. In this aspect, the hook and loop fastener can be attached to the display surface such that a notch 820 is formed when at least a portion of the display surface is wrapped around the cord 830. As can be appreciated, the size of the notch can be varied by the user of the display device 800 so that the device can be attached to cords of differing sizes. In one aspect, the display surface can be formed from a single piece of flexible material. In another aspect, the display surface 810 can be on both a front side and a rear side of the device. For example, when a flexible display is wrapped around the cord 830, a message can appear to be on two sides of the display device 800. In still another aspect, the hook and loop fastener 840 can be attached to the display surface with glue or other adhesives and the like.

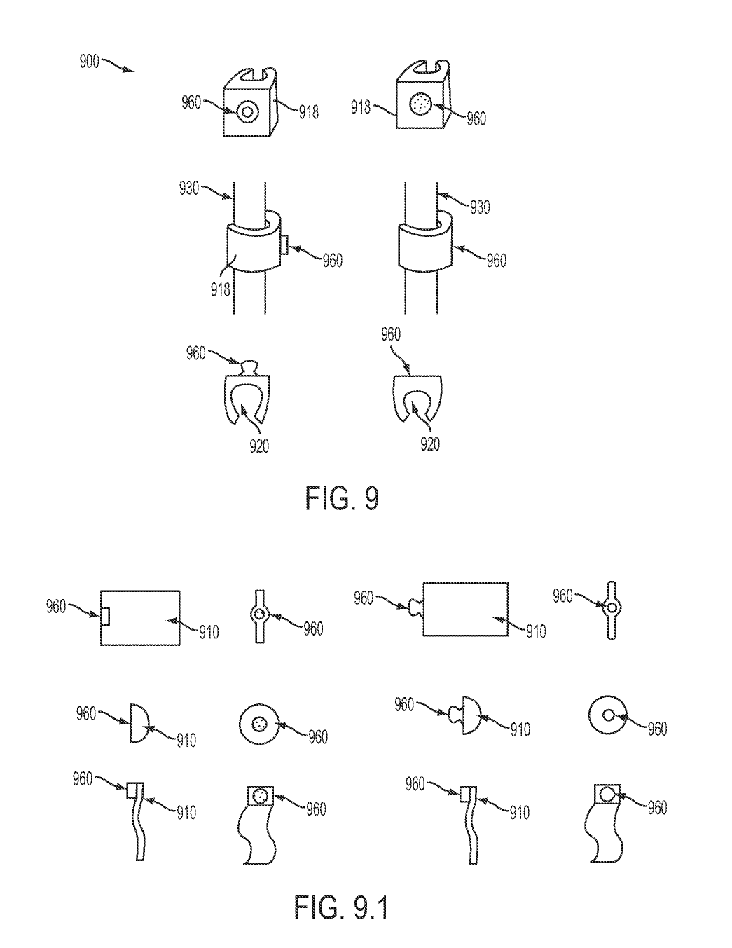

Referring to FIG. 9, in one aspect, the display device 900 can comprise the clip 918 defining a notch 920 and a detachable display surface 910. In this aspect, the clip can comprise a button or snap 960 on an opposed side of the clip form the notch 920. A back side of the display surface can comprise a button or snap configured to matingly engage the button or snap 960 of the clip 918. As can be appreciated, because the display surface is detachable via the button or snap, numerous display surfaces 910 of various shapes and sizes can be provided. Further, the detachable display surface can be easily removed when desired. As illustrated in FIGS. 9 and 9.1, the button or snaps can have a male or female side formed on the clip 918, and a corresponding female or male side formed on the display surface 910.

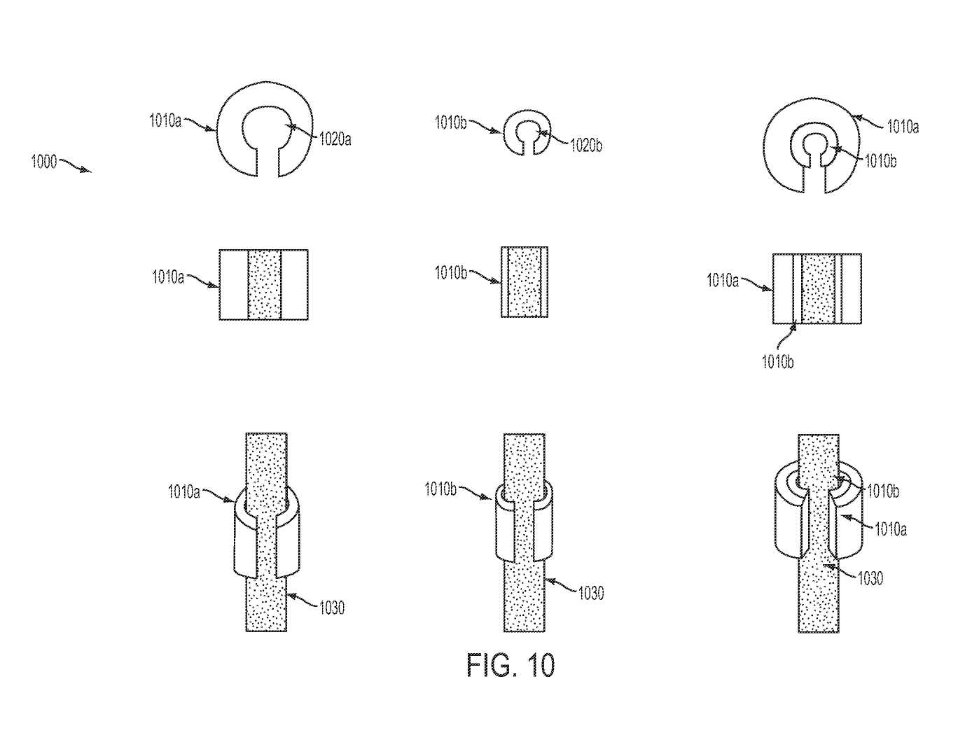

In one aspect, the display device can comprise a plurality of display surfaces. With reference to FIG. 10, the plurality of display devices can comprise a first display surface 1010a having a first notch 1020a and a second display surface 1010b having a second notch 1020b. In this aspect, the second notch can be sized and shaped for attachment to a predetermined cord 1030, and the first notch can be sized and shaped for attachment to the first display surface 1010a. Thus, it is contemplated that a variety of sized of display surfaces could be provided to a user, and the user can stack the display devices 1000 together as necessary for attachment of the display surfaces to cords of differing diameters.

As previously discussed, the display device 10 can be manufactured in many shapes, sizes, and colors. It can be manufactured in one piece or multiple pieces, and it can be made from like material or several different materials. The shape, color and size of the display device can be modified to express the intent of the variation, and the display device can be printed or painted with messages, logos, countries of origin etc. For example, one embodiment of the display device could be a pink tag for beast cancer awareness, or it could be pink because a young girl likes the color pink. In another example, a display device could be in the shape might be a football with a team's logo on it or a cross to show a religious affiliation.

It is contemplated that the display device 10 can be attached to any cord 30 sized to fit into the notch 20 of the display device. It is further contemplated that the display device can be used for the purpose of presenting advertising, messages, and other things of interest to the public and/or the user. Because the display device 10 can be viewed by the public, it is contemplated that the display device can attach to a cord in such a fashion that the display surface of the display device is clearly visible. In one aspect, the secure attachment of the notch 20 of the display device to the cord 30 allows the display device to remain attached to the cord such that travel or use during physical activity (for example, in the case of MP3 headphones) will not dislodge the display device from the cord

It is further contemplated that the display device 10 can be used to convey a wide variety of messages or applications. For example, the display device can be used to display colors or simple shapes for children. It can also be used for advertisement purposes or to display messages, interests, pride in geographical locations or sports teams. It is contemplated that the display device can encompass some or all of the aspects shown in the figures above.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A display device for a cord comprising:
a display surface configured for displaying a message; and
an opposed rear surface, wherein at least one notch is defined therein a portion of the rear surface, and wherein the at least one notch is configured for selective attachment to a portion of the cord.

2. The display device of claim 1, wherein at least a portion of the display surface is shaped to display a message.

3. The display device of claim 2, wherein at least a portion of the display surface is substantially planar.

4. The display device of claim 3, wherein at least an image is printed on the display surface.

5. The display device of claim 4, wherein the display device is a monolithic device.

6. A display device for a cord comprising:
a display surface configured for displaying a message; and
an opposed rear surface, wherein a pair of opposed arms extend from the rear surface, wherein at least one notch is defined between the pair of opposed arms, and wherein the at least one notch is configured for selective attachment to a portion of the cord.

7. The display device of claim 6, wherein at least a portion of the display surface is shaped to display a message.

8. The display device of claim 7, wherein at least a portion of the display surface is substantially planar.

9. The display device of claim 8, wherein at least an image is printed on the display surface.

10. The display device of claim 9, wherein the display device is a monolithic device.

11. A display device for a cord comprising:
a display surface configured for displaying a message;
an opposed rear surface; and
an outer wall extending between the display surface and the opposed rear surface, wherein at least one notch is defined therein at least a portion of the outer wall, and wherein the at least one notch is configured for selective attachment to a portion of the cord.

12. The display device of claim 11, wherein the at least one notch comprises a plurality of notches, wherein a first notch of the plurality of notches is defined in a first side of the outer wall, wherein a second notch of the plurality of notches is defined is a second side of the outer wall, and wherein the second wall is opposed to the first wall.

13. The display device of claim 12, wherein at least a portion of the display surface is shaped to display a message.

14. The display device of claim 13, wherein at least a portion of the display surface is substantially planar.

15. The display device of claim 14, wherein at least an image is printed on the display surface.

16. The display device of claim 15, wherein the display device is a monolithic device.

17. A display device for a cord comprising:
a display surface configured for displaying a message; and
an opposed rear surface, wherein at least one notch is defined therein a portion of the rear surface, and wherein the at least one notch comprises means for selective compressive and frictional attachment to a portion of the cord.

18. The display device of claim 17, wherein at least a portion of the display surface is shaped to display a message.

19. The display device of claim 18, wherein at least a portion of the display surface is substantially planar, and wherein at least an image is printed on the display surface.

20. The display device of claim 17, wherein the display device is a monolithic device.
